(19) United States
(12) Patent Application Publication
(10) Pub. No.: US 2018/0310626 A1
(43) Pub. Date: Nov. 1, 2018

(54) E-CIGARETTE WITH REPLACEABLE ATOMIZATION CORE

(71) Applicant: O-NET AUTOMATION TECHNOLOGY (SHENZHEN) COMPANY LIMITED, Shenzhen (CN)

(72) Inventors: Yongquan Zhou, Shenzhen (CN); Cheng Wang, Shenzhen (CN); Bo Zhou, Shenzhen (CN)

(21) Appl. No.: 16/021,025

(22) Filed: Jun. 28, 2018

Related U.S. Application Data
(63) Continuation of application No. PCT/CN2016/076250, filed on Mar. 14, 2016.

(30) Foreign Application Priority Data
Dec. 28, 2015 (CN) 201510999462.3

(51) Int. Cl. A24F 47/00; A24F 7/00; H05B 3/46

(52) U.S. Cl. CPC A24F 47/008; H05B 2203/021; H05B 3/46; A24F 7/00

(57) ABSTRACT

The present invention relates to an e-cigarette with a replaceable atomization core. The e-cigarette includes an e-cigarette main body, an atomization core and the power supply part. The e-cigarette with a replaceable atomization core is designed in the present invention. The atomization core is disposed between the e-cigarette main body and the power supply part, and e-liquid in the liquid storage tank produces aerosol when the atomization core is heated; in addition, the atomization core has a detachable structure, and the atomization core can be directly replaced when the atomization core is damaged, thereby reducing use costs; because the atomization core is detachable, the liquid storage tank is repeatedly added with e-liquid, thereby saving resources.

### CROSS-REFERENCE TO RELATED APPLICATIONS

The present application is a Continuation Application of PCT application No. PCT/CN2016/076250 filed on Mar. 14, 2016, which claims the benefit of Chinese Patent Application No. 201510999462.3 filed on Dec. 28, 2015. The contents of all of the above are hereby incorporated by reference.

### TECHNICAL FIELD

The present invention relates to the field of e-cigarettes, in particular to an e-cigarette with a replaceable atomization core.

### BACKGROUND

E-cigarettes, also known as electronic cigarettes, are mainly used to quit smoking and replace tobacco cigarettes. The e-cigarettes have similar appearance and taste to the tobacco cigarettes, but generally do not contain tar, suspended particles, and other harmful components found in the tobacco cigarettes. The e-cigarettes do not produce pervasive or lingering secondhand smoke.

The e-cigarette is mainly composed of an atomizer and a power supply assembly. Usually, the atomizer includes a liquid storage tank, a heating filament, a heating filament support body, positive and negative electrodes of the atomizer, and so on. Generally, the heating filament winds around the heating filament support body to form a heating component of the e-cigarette. Two ends of the heating filament are electrically connected to positive and negative electrodes of the atomizer through through-holes on the base, so as to implement heating.

However, existing e-cigarettes have the following problems, which are specifically:

1. An atomization core in the atomizer is generally composed of glass fibers. The glass fiber wick is prone to generate glass fiber crumbs when being heated. When an aerosol produced after e-liquid atomization is inhaled into lungs by a user, the glass fiber crumbs entering the lungs of the human body are difficult to discharge, and the glass fiber crumbs easily pierce through mucous membranes like glass, not conducive to human health.

2. The atomization core of the atomizer is usually a non-detachable structure, that is, the atomizer has a non-replaceable atomization core. If the atomization core is damaged, the entire atomizer cannot be used. This increases use costs of the e-cigarette.

3. Generally, the atomizer has a complex structure and requires high production costs.

### SUMMARY

To overcome the foregoing defects of the prior art, a technical issue to be resolved in the present invention is to provide an e-cigarette with a replaceable atomization core, to facilitate replacement of an atomization core for the e-cigarette.

A technical solution used to resolve the technical issue in the present invention is to provide an e-cigarette with a replaceable atomization core, including:

an e-cigarette main body, where the e-cigarette main body includes a mouthpiece, and a main aerosol passage and a liquid storage tank that communicate with the mouthpiece, the mouthpiece is disposed at the top of the e-cigarette main body, the main aerosol passage also communicates with the bottom of the e-cigarette main body, and the liquid storage tank is configured to store e-liquid;

an atomization core, where the atomization core is disposed between the e-cigarette main body and a power supply part, and the atomization core includes an atomization base and a heating component, the atomization base includes a groove for accommodating the heating component and an atomization base aerosol passage that communicates with the main aerosol passage, the heating component includes a ceramic substrate and a heating filament that winds around the ceramic substrate, the heating filament is electrically connected to the power supply part, and the ceramic substrate includes a hollow mini-hole communicates with the liquid storage tank; and
the power supply part, where positive and negative poles of the power supply part are electrically connected to two ends of the heating filament, respectively.

An exemplary solution is that the e-cigarette further includes a holding base for accommodating the atomization core, the holding base is disposed on the power supply part, the holding base includes a liquid-guiding groove and a first accommodating cavity, the atomization core is disposed in the first accommodating cavity, and two ends of the heating component pass through the liquid-guiding groove to communicate with the liquid storage tank.

An exemplary solution is that a first sealing part is disposed at the bottom of the atomization base, and the first sealing part abuts against a surface of the first accommodating cavity of the holding base, so as to prevent the e-liquid from overflowing.

An exemplary solution is that a second sealing part is disposed at the top of the atomization base, and the second sealing part abuts against an inner wall of the main aerosol passage, so as to prevent the e-liquid from overflowing.

An exemplary solution is that the atomization core includes a first conductor and a second conductor that are electrically connected to two ends of the heating filament, respectively, the first conductor is electrically connected to the holding base, the e-cigarette further includes an inner electrode electrically connected to the second conductor, and the holding base and the inner electrode are electrically connected to the positive and negative poles of the power supply part, respectively.

An exemplary solution is that an insulation ring is disposed between the holding base and the inner electrode.

An exemplary solution is that the heating component further includes tightening members disposed at both ends of the ceramic substrate, the tightening members each are electrically connected to the heating filament, and the tightening members at both ends are electrically connected to the first conductor and the second conductor, respectively.

An exemplary solution is that a wire storage groove is disposed at the bottom of the holding base.

An exemplary solution is that the e-cigarette further includes a connecting base, where the connecting base is separately connected to the holding base and the power supply part.

An exemplary solution is that a second accommodating cavity is provided at the bottom of the e-cigarette main body, and the atomization core is disposed in the second accommodating cavity.

Compared with the prior art, the present invention has the following beneficial effects: An e-cigarette with a replaceable atomization core is designed in the present invention, where the atomization core is disposed between the e-cigarette main body and the power supply part, and the e-liquid of the liquid storage tank produces aerosol when the atomization core is heated; in addition, the atomization core has a detachable structure, and the atomization core can be directly replaced when the atomization core is damaged, thereby reducing use costs; because the atomization core is detachable, e-liquid can be refilled into the liquid storage tank, thereby saving resources; and the e-cigarette in the present invention features a simple structure and easy assembly, thereby reducing production costs.

### BRIEF DESCRIPTION OF DRAWINGS

The following describes the present invention in more detail with reference to accompanying drawings and embodiments. In the accompanying drawings:

FIG. 1 is a schematic structural diagram of an e-cigarette with a replaceable atomization core according to the present invention;

FIG. 2 is a schematic sectional diagram of an e-cigarette main body according to the present invention;

FIG. 3 is a schematic sectional structure diagram of an e-cigarette main body and an atomization core according to the present invention;

FIG. 4 is a schematic structural diagram of an atomization core and a holding base according to the present invention;

FIG. 5 is a schematic structural diagram of an atomization base according to the present invention;

FIG. 6 is a schematic sectional structure diagram of an atomization base according to the present invention;

FIG. 7 is a schematic structural diagram of a heating component according to the present invention; and

FIG. 8 is a schematic sectional structure diagram of an atomization base and a heating component according to the present invention.

### DESCRIPTION OF EMBODIMENTS

Herein, exemplary embodiments of the present invention are described in detail with reference to the accompanying drawings.

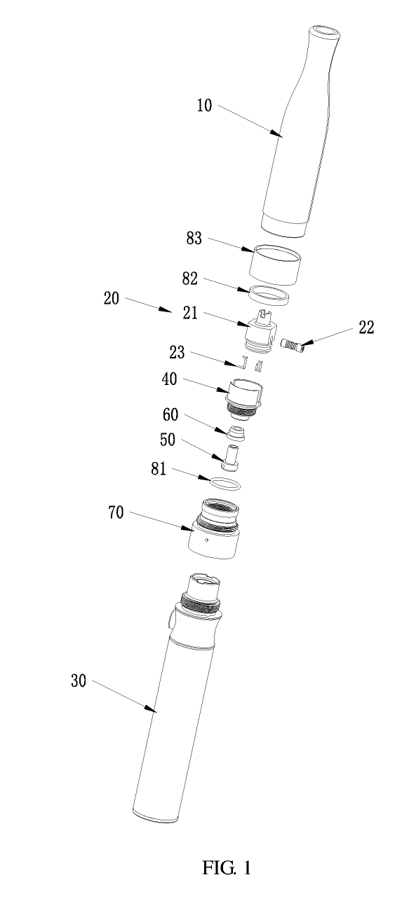

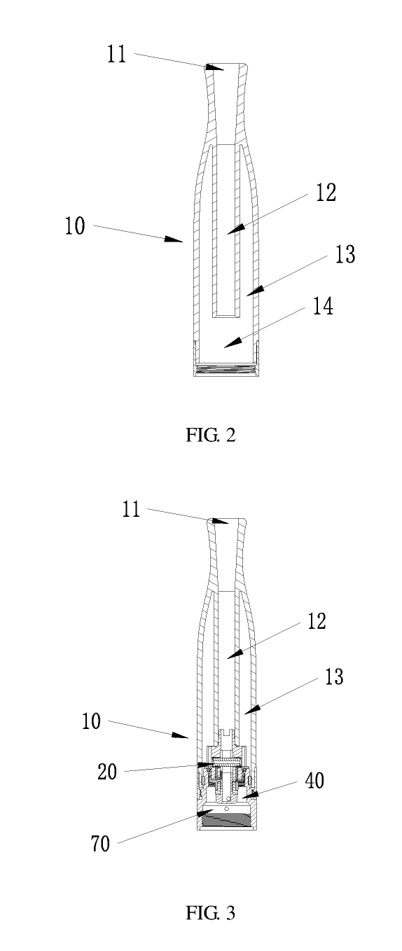

As shown in FIG. 1, FIG. 2, and FIG. 3, the present invention provides a preferred embodiment of an e-cigarette with a replaceable atomization core.

An e-cigarette with a replaceable atomization core 20 includes an e-cigarette main body 10, the atomization core 20, and a power supply part 30. The atomization core 20 is disposed between the e-cigarette main body 10 and the power supply part 30. The atomization core 20 has a detachable structure, and when the e-cigarette main body 10 and the power supply part 30 are removed, the atomization core 20 can be directly replaced, or the atomization core 20 is removed separately, to fill e-liquid into the e-cigarette main body 10.

Specifically,

In this embodiment, referring to FIG. 2, the e-cigarette main body 10 includes a mouthpiece 11 and a main aerosol passage 12 and a liquid storage tank 13 that communicate with the mouthpiece 11, the mouthpiece 11 is disposed at the top of the e-cigarette main body 10, the main aerosol passage 12 also communicates with the bottom of the e-cigarette main body 10, and the liquid storage tank 13 is configured to store e-liquid. The main aerosol passage 12 is disposed in the middle, the liquid storage tank 13 is disposed around the main aerosol passage, and the mouthpiece 11 is disposed at one end of the main aerosol passage 12. Alternatively, the liquid storage tank 13 is disposed in the middle, and the main aerosol passage 12 is disposed around the liquid storage tank 13.

The atomization core 20 is disposed between the e-cigarette main body 10 and the power supply part 30. The atomization core 20 includes an atomization base 21 and a heating component 22. The heating component 22 is disposed on the atomization base 21. The heating component 22 communicates with the main aerosol passage 12, and the heating component 22 also communicates with the liquid storage tank 13. The heating component 22 is electrically connected to the power supply part 30 to implement heating. The e-liquid in the liquid storage tank 13 flows into the heating component 22 and produces aerosol when being heated. The aerosol spreads to the main aerosol passage 12.

The power supply part 30 includes positive and negative poles, and the positive and negative poles are electrically connected to two ends of the heating component 22, respectively.

Further, with reference to FIG. 2 and FIG. 3, a second accommodating cavity 14 is provided at the bottom of the e-cigarette main body 10, and the atomization core 20 is disposed in the second accommodating cavity 14. That is, the power supply part 30 is directly spliced with the e-cigarette main body 10, a housing of the e-cigarette main body 10 and a housing of the power supply part 30 forms a main housing of the e-cigarette.

In this embodiment, the e-cigarette further includes a holding base 40. The holding base 40 is connected to the atomization core 20, and the holding base 40 is also connected to the e-cigarette main body 10, so as to fasten the atomization core 20 onto the e-cigarette main body 10, for example, to connect to the second accommodating cavity 14. Alternatively, the holding base 40 is connected to the power supply part 30, to fasten the atomization core 20 onto the power supply part 30.

The e-cigarette further includes an inner electrode 50. In this case, the holding base 40 is made of a conductive material. The holding base 40 and the inner electrode 50 are connected to two ends of the heating component 22, respectively. In addition, the holding base 40 and the inner electrode 50 are connected to the positive and negative poles of the power supply part 30, respectively, so that the positive and negative poles of the power supply part 30 are connected to the heating component 22, to supply electric power for heating the heating component 22.

An insulation ring 60 is disposed between the holding base 40 and the inner electrode 60, to prevent a short circuit between the holding base 40 and the inner electrode 50.

Further, the holding base 40 may be integrated with the atomization core 20 to form a new atomization core structure. The new atomization core structure can be directly removed from the e-cigarette main body 10 or the power supply part 30.

In this embodiment, the e-cigarette also includes a connecting base 70. The connecting base 70 is separately connected to the holding base 40 and the power supply part 30. Alternatively, the connecting base 70 is directly integrated with the power supply part 30.

In this embodiment, the e-cigarette also includes an elastic ring 81 disposed between the connecting base 70 and the holding base 40, a first mounting accessory 82, and a second mounting accessory 83, so as to facilitate connection of the holding base 40 to the e-cigarette main body 10.

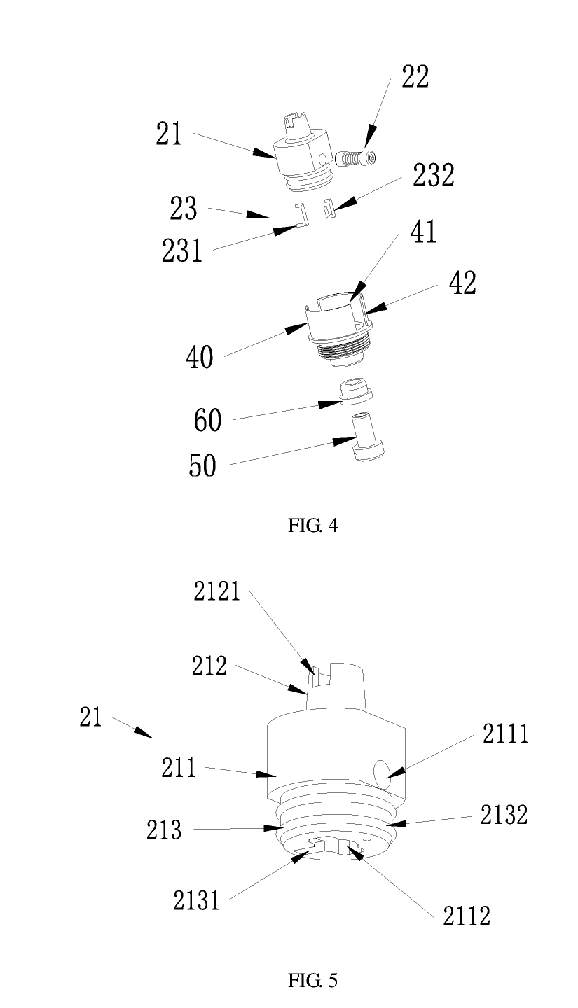

As shown in FIG. 4, the present invention provides an exemplary embodiment of an atomization core integrated with a holding base.

The atomization core 20 is disposed between the e-cigarette main body 10 and the power supply part 30. The atomization core 20 includes an atomization base 21 and a heating component 22. The heating component 22 is disposed on the atomization base 21. The atomization core 20 further includes a conductor 23 electrically connected to two ends of the heating component 22. The conductor 23 includes a first conductor 231 and a second conductor 232, the first conductor 231 is electrically connected to the holding base 40, and the second conductor 232 is electrically connected to the inner electrode 50, and the holding base 40 and the inner electrode 50 are electrically connected to the positive and negative poles of the power supply part 30, respectively.

In addition, the holding base 40 includes a liquid-guiding groove 42 and a first accommodating cavity 41, the atomization core 20 is disposed in the first accommodating cavity 41, and the two ends of the heating component 22 pass through the liquid-guiding groove 42 to communicate with the liquid storage tank 13.

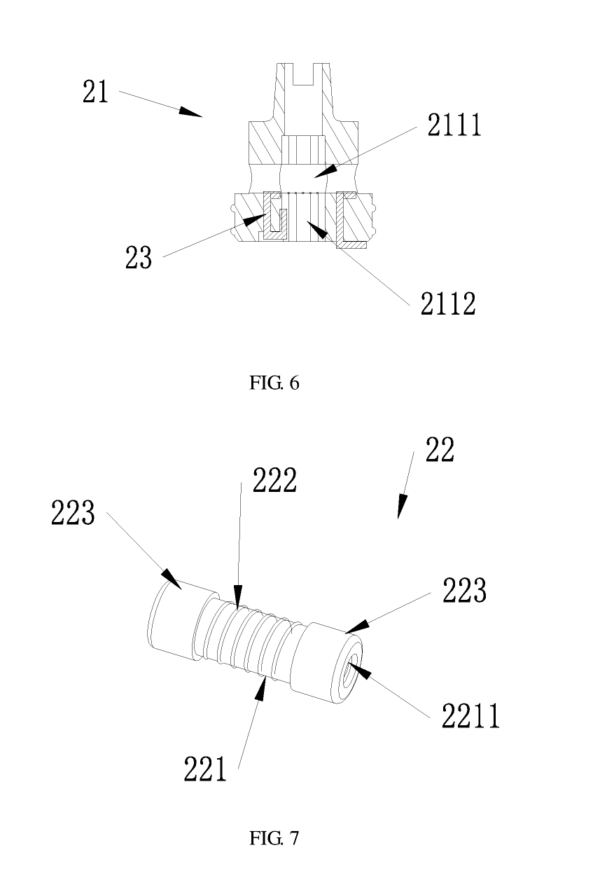

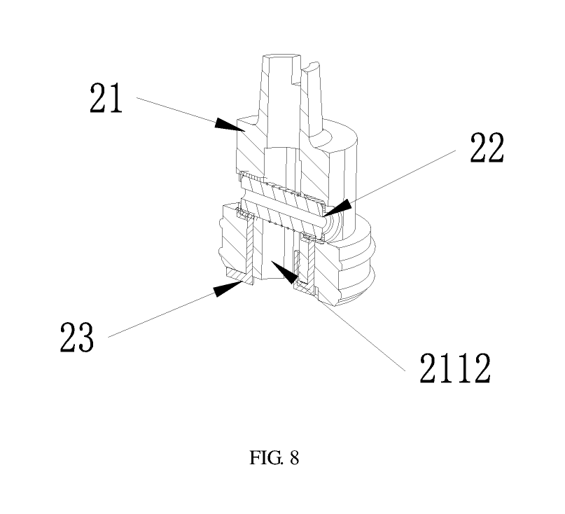

As shown in FIG. 5, FIG. 6, FIG. 7, and FIG. 8, the present invention provides an exemplary embodiment of an atomization base.

An atomization core 20 is disposed between an e-cigarette main body 10 and a power supply part 30, and the atomization core 20 includes an atomization base 21 and a heating component 22. The atomization base 21 includes a groove 2111 for accommodating the heating component 22 and an atomization base aerosol passage 2112 that communicates with a main aerosol passage 12. The heating component 22 includes a ceramic substrate 221 and a heating filament 222 that winds around the ceramic substrate 221. The heating filament 222 is electrically connected to the power supply part 30, and the ceramic substrate 221 includes a hollow mini-hole 2211. The hollow mini-hole 2211 communicates with a liquid storage tank 13.

The heating component 22 further includes tightening members 223 disposed at both ends of the ceramic substrate 221. The tightening members 223 each are electrically connected to the heating filament 222, and the tightening members 223 at both ends are electrically connected to a first conductor 231 and a second conductor 232, respectively.

The atomization base 21 is also made of a ceramic material, to prevent crumbs from falling off in the heating process.

A conductor 23 is separately disposed on inner walls of both sides of an atomization base aerosol passage 2112 to prevent a short circuit caused by mutual contact. In addition, a wire storage groove is included in the atomization base 21 and configured to accommodate the second conductor 232, to avoid a short circuit caused by electrical connection between the second conductor 232 and the holding base 40.

Further, the atomization base 21 includes an atomization base main body 211, a first main body 212 disposed at the top of the atomization base main body 211, and a second main body 213 disposed at the bottom of the atomization base main body 211. A second main body 2121 is disposed in the first main body 212. The second main body 2121 is configured to divert e-liquid droplets condensed on the atomization base aerosol passage 2112 back into the atomization base 21, so that the e-liquid droplets are atomized into aerosol again. In this way, the e-liquid is reclaimed and use costs are reduced.

Further, a first sealing part 2131 is disposed on an outer surface of the second main body 213. The first sealing part 2131 abuts against a surface of a first accommodating cavity 41 of the holding base 40 to prevent the e-liquid from overflowing.

A second sealing part is disposed at the top of the atomization base main body 211, and the second sealing part abuts against an inner wall of the main aerosol passage 12, to prevent the e-liquid from overflowing.

The foregoing descriptions are merely exemplary embodiments of the present invention, but are not intended to limit the scope of the present invention. Any modification, equivalent replacement, or improvement made without departing from the application patent scope of the present invention should fall within the protection scope of the present invention.

What is claimed is:

1. An e-cigarette with a replaceable atomization core, comprising:
an e-cigarette main body, wherein the e-cigarette main body comprises a mouthpiece, and a main aerosol passage and a liquid storage tank that communicate with the mouthpiece, the mouthpiece is disposed at the top of the e-cigarette main body, the main aerosol passage also communicates with the bottom of the e-cigarette main body, and the liquid storage tank is configured to store e-liquid;
an atomization core, wherein the atomization core is disposed between the e-cigarette main body and a power supply part, and the atomization core comprises an atomization base and a heating component, the atomization base comprises a groove for accommodating the heating component and an atomization base aerosol passage that communicates with the main aerosol passage, the heating component comprises a ceramic substrate and a heating filament that winds around the ceramic substrate, the heating filament is electrically connected to the power supply part, and the ceramic substrate comprises a hollow mini-hole communicates with the liquid storage tank; and
the power supply part, wherein positive and negative poles of the power supply part are electrically connected to two ends of the heating filament, respectively.

2. The e-cigarette according to claim 1, further comprising a holding base for accommodating the atomization core, the holding base is disposed on the power supply part, the holding base comprises a liquid-guiding groove and a first accommodating cavity, the atomization core is disposed in the first accommodating cavity, and two ends of the heating component pass through the liquid-guiding groove to communicate with the liquid storage tank.

3. The e-cigarette according to claim 2, wherein a first sealing part is disposed at the bottom of the atomization base, and the first sealing part abuts against a surface of the first accommodating cavity of the holding base, so as to prevent the e-liquid from overflowing.

4. The e-cigarette according to claim 3, wherein a second sealing part is disposed at the top of the atomization base, and the second sealing part abuts against an inner wall of the main aerosol passage, so as to prevent the e-liquid from overflowing.

5. The e-cigarette according to claim 2, wherein the atomization core comprises a first conductor and a second conductor that are electrically connected to two ends of the heating filament, respectively, the first conductor is electrically connected to the holding base, the e-cigarette further comprises an inner electrode electrically connected to the second conductor, and the holding base and the inner electrode are electrically connected to the positive and negative poles of the power supply part, respectively.

6. The e-cigarette according to claim 5, wherein an insulation ring is disposed between the holding base and the inner electrode.

7. The e-cigarette according to claim 6, wherein the heating component further comprises tightening members disposed at both ends of the ceramic substrate, the tightening members each are electrically connected to the heating filament, and the tightening members at both ends are electrically connected to the first conductor and the second conductor, respectively.

8. The e-cigarette according to claim 6, wherein a wire storage groove is disposed at the bottom of the holding base.

9. The e-cigarette according to claim 2, further comprising a connecting base, wherein the connecting base is separately connected to the holding base and the power supply part.

10. The e-cigarette according to claim 1, wherein a second accommodating cavity is provided at the bottom of the e-cigarette main body, and the atomization core is disposed in the second accommodating cavity.
